(19) United States
(12) Patent Application Publication
(10) Pub. No.: US 2008/0259028 A1
(43) Pub. Date: Oct. 23, 2008

(54) Hand glove mouse

(76) Inventors: Brenda Teepell, Woodlawn (CA); David Moulaison, Ottawa (CA); Robert Poitras, Woodlawn (CA)

Correspondence Address: KRAMER & AMADO, P.C., 1725 DUKE STREET, SUITE 240, ALEXANDRIA, VA, 22314, US

(21) Appl. No.: 11/785,656

(22) Filed: Apr. 19, 2007

(51) Int. Cl. G06F 3/033

(52) U.S. Cl. 345/158

(57) ABSTRACT

A hand glove mouse, including first, second and third buttons or sensors and a cursor positioner that is not a motion or tilt sensor (i.e., a roller ball, a light sensor, etc.) for adjusting the position of a cursor on a computer monitor. In one embodiment the positioner and buttons are located on a users body, but not on the user's fingertips. In another embodiment, the first, second and third sensors are load sensors on the user's fingertips with an actuation threshold above the load generated by typing. The hand glove mouse also includes a communication means communicating signals generated by the first, second and third buttons or sensors, and by the cursor positioner, to the computer.

### BACKGROUND OF THE INVENTION

1. Field of the Invention

This invention relates generally to a variety of a mouse for use with a personal computer wherein one or more components of the mouse are worn on the body of the user of the computer.

2. Description of Related Art

In connection with computers, a mouse (plural mice or mouses) functions as a pointing device by detecting two-dimensional motion. Conventionally, the two-dimensional motion is detected relative to a supporting surface. Physically, a conventional mouse consists of a small case, held under one of the hands of a computer user. Typically, a mouse includes one or more buttons included in the small case held under the hand of the user.

A mouse also sometimes features other elements, such as “wheels.” Wheels allow the user to perform various system-dependent operations. Some mice include additional buttons or features to add more control or dimensional input. The motion of a mouse typically translates into the motion of a pointer on a display.

Conventional mice have a cord attached to a rear portion of the small case held under the user's hand. Some consider this cord to be suggestive of a tail. Thus, the name mouse for the device is believed to derive from the resemblance of typical models to the common eponymous rodent.

The conventional mice described above require reaching and positioning. This necessary reaching and positioning is often performed repetitively innumerable times by a user. Consequently, wrist and neck injuries often developed in users of mice.

Further, the necessity of moving the user's hand from a mouse to a keyboard, and back and forth between the two repeatedly, requires additional body movements potentially resulting in additional injury or risk of injury, and additional time, resulting in increased inefficiency of operating the computer. Elimination of unnecessary motion and time in the use of a mouse would improve productivity and reduce risk of injury.

Some mice have been developed wherein sensors are relocated from the small case held under the user's hand onto a glove worn on the user's hand. However, many such versions of a mouse place the sensors or switches of the mouse on the fingertips of the glove. This location for the sensors or switches of a mouse either prohibit or inhibit the ability of the user wearing the glove containing the sensors to type on a keyboard without actuating the sensors or switches of the mouse at a time when an actuation of those sensors or switches is not desired.

Other types of mice utilize tilt or movement sensors. However, in practice, it is very difficult to operate a mouse incorporating tilt or movement sensors on the hand of the user without causing inadvertent, unintentional and undesirable movement of a cursor position on a computer monitor associated with movement actuated by the sensors of the mouse. Thus, there is a need for an ergonomic mouse that reduces the amount of movement in the body of a computer user when operating both the mouse and a keyboard, a need for reducing a risk of bodily injuries to the user of the computer, a need for enabling typing on a keyboard and operation of the mouse without interference between these two functions of operating a computer, and a need for operating a mouse using sensors positioned on the body of the user without inadvertent movement of a cursor position on a computer monitor caused by the implementation of tilt or movement sensors in the mouse.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In light of the present need for a hand glove mouse overcoming one or more of the problems described herein, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

According to the foregoing, various embodiments position mouse sensors and switches on a glove worn on the hand of a user in a location other than the portion of the hand used for typing on a computer keyboard (i.e. fingertips). For example, some embodiments reposition the sensors or switches to the knuckle on a finger closest to the fingertip, rather than on the fingertip. Other embodiments position the sensor or switch between the two knuckles on the finger closest to the fingertip. Thus, various embodiments leave the fingertips of the user unobstructed for typing on a computer keyboard while orienting sensors and switches for a mouse on the fingers of the computer user.

Various embodiments include an optical sensor on a glove for positioning a cursor on a computer screen. In some embodiments, the optical sensor is located in the palm of the glove. It is believed that an optical sensor and corresponding positioning circuitry is less prone to inadvertent cursor positioning than other known sensors used for cursor positioning of a mouse in a mouse glove, as described above.

According to the foregoing, various exemplary embodiments include a hand glove mouse that fits on fingers of a user, attaches to the top of the users wrist, contains a light wrist support, or any combination of one or more of the foregoing features. Thus, in some embodiments, the hand glove mouse fits on three fingers such as the thumb, pointer finger and middle finger of the user.

Various embodiments enable the user to type with fingertips unimpeded. In some embodiments, a thumb sensor switch is used to correspond to a third click or document scroll function of the mouse. In some embodiments, instead of an optical sensor, a motion ball is oriented on the user's body for mouse movement. Thus, in some embodiments a motion ball is located on the palm of the user's hand.

### BRIEF DESCRIPTION OF THE DRAWINGS

In order to better understand various exemplary embodiments, reference is made to the accompanying drawings, wherein:

FIG. 1 shows a bottom perspective view of the palm of a right hand of a computer user with an exemplary embodiment of a hand glove mouse installed thereon; and

FIG. 2 shows a perspective view from the left of the right hand of the computer user with the exemplary embodiment of the hand glove mouse of FIG. 1 installed thereon.

### DETAILED DESCRIPTION OF THE PREFERRED EMBODIMENTS OF THE INVENTION

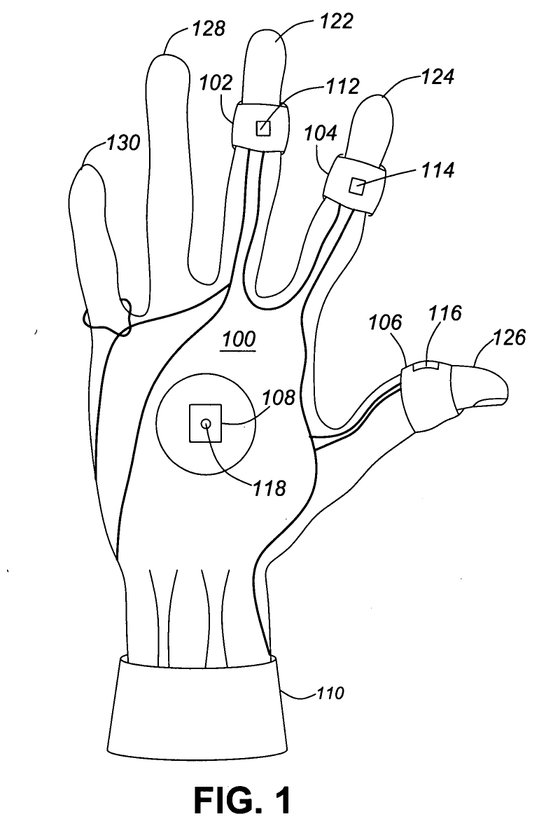

Referring now to the drawings, in which like numerals refer to like components or steps, there are disclosed broad aspects of various exemplary embodiments. FIG. 1 is a bottom perspective view showing the right hand of a computer user with an exemplary embodiment of a hand glove mouse 100 installed thereon.

The hand glove mouse 100 includes a right button 112, a left button 114, and an on/off button 116. The right button 112 is located on the bottom of the middle finger 122 of the user. The left button 114 is located on the bottom of the pointer finger 124 of the user. Similarly, the on/off button 116 is located on the bottom of the thumb 126 of the user.

In the embodiment of the hand glove mouse 100 depicted in FIG. 1, the right button 112 is attached to the middle finger 122 of the user by right button attachment 102. Likewise, the left button 114 is attached to the pointer finger 124 of the user by left button attachment 104. Similarly, the on/off button 116 is attached to the thumb 126 of the user by way of on/off button attachment 106.

Right button attachment 102, left button attachment 104, and on/off button attachment 106 are depicted in the embodiment of hand glove mouse 100 as sleeves surrounding the respective fingers 122, 124, 126 of the user in a manner that resembles a band-aid placed on the finger of the user. However, it should be apparent that in other embodiments of a hand glove mouse 100, other mechanisms and devices are used to attach the right button 112, the left button 114 and the on/off button 116 to the same or different locations on the body of the user.

As depicted in exemplary embodiment of hand glove mouse 100, the right button 112 and right button attachment 102 are located approximately in the vicinity of the outer most knuckle of the middle finger 122. Similarly, the left button 114 and left button attachment 104 are located in the vicinity of the outer most knuckle of the pointer finger 124. Likewise, in the depicted embodiment of hand glove mouse 100, the on/off button 116 and on/off button attachment 106 are located in the vicinity of the outer most knuckle of the thumb 126.

In other embodiments, the right button 112, right button attachment 102, left button 114, left button attachment 104, on/off button 116, and on/off button attachment 106 are located between the two outer most knuckles of the respective fingers 122, 124, 126. It should be apparent that, in still other embodiments of hand glove mouse 100, each of the sensors, buttons and attachments, according to whatever combination of sensors, buttons and attachments are selected for that embodiment, are located on other portions of the user's hand or body.

It is believed to be preferable that the exemplary hand glove mouse 100 be operated on a hard surface. This is believed to be beneficial for the reason that the right button 112, left button 114 and on/off button 116 can be easily actuated on such a hard surface. However, it is believed that the exemplary hand glove mouse 100 can also be operated on surfaces that are not hard. Examples of surfaces envisioned as being used to actuate the right button 112, left button 114 and on/off button 116 include a desktop, an edge of a keyboard, an edge of a monitor, an armrest of the user's chair or other surfaces easily reached by the portion of the user's body on which the hand glove mouse 100 is attached.

In order to minimize the amount of additional weight carried by the portion of the body of the computer user on which the hand glove mouse 100 is attached, it is believed to be desirable that the device be manufactured from a light weight material. Similarly, in order to facilitate the installation of the device on the body of the user, and to facilitate the removal of the device from the body of the user, it is believed to be desirable that the hand glove mouse 100 be manufactured from an elastic and flexible material. For example, a thin neoprene is believed to be a desirable material from which to manufacture the hand glove mouse 100.

In some embodiments of the hand glove mouse 100, the sensors and buttons incorporated therewith communicate with a processor of the computer by way of wiring connected to the sensors. In some embodiments, the wiring is a flexible braided wiring. In some embodiments the wiring creates a physical connection extending uninterrupted from each sensor and button in the hand glove mouse 100 to the processor of the computer.

In other embodiments, a radio frequency (RF) transmitter is used to communicate signals from each sensor or button on the hand glove mouse 100 to the processor of the computer. Thus, any known means of wireless communication is used in connection with the hand glove mouse 100 for embodiments of the device that are cordless.

In various exemplary embodiments, circuitry and other hardware necessary to derive cursor positioning and mouse click information, and to communicate that information to the processor of the computer, is installed in a wristband 110 included in the hand glove mouse 100. In other embodiments, such circuitry is included in the housing of the processor of the computer and the information received from the buttons and sensors in the hand glove mouse 100 is processed within the housing of the computer. Thus, in such embodiments, RF circuitry, or hardwiring, or other means of communication is used to transmit raw data from the switches and sensors of the hand glove mouse 100 to the computer. In still other embodiments, such information is transmitted by wires coupled to a mechanical connector (not shown) mounted at, for example, the wristband 110 of the hand glove mouse 100.

In some embodiments, the right button 112, the left button 114 and the on/off button 116 consist of load sensors. In some such embodiments, the load sensors have a threshold and when pressure is exerted on the load sensor beyond the threshold, then the function of the clicking of the button is actuated.

It should be apparent that the right button attachment 102, the left button attachment 104 and the on/off button attachment 106 are adjustable in some embodiments such that the location of the right button 112, left button 114 and on/off button 116 can be adjusted on the user's body in such embodiments. Further, in some embodiments, the wristband 110 functions as the on/off button attachment 106, such that the on/off button 116 is mounted on the wristband 110, not on the thumb 126 of the user.

In various exemplary embodiments, the cursor positioner 118 is an optical sensor. In other embodiments, the cursor positioner 118 is a rollerball. It should be apparent that other means of positioning a cursor are implemented as the cursor positioner 118 in other embodiments. The cursor positioner attachment 108 attaches the cursor positioner 118 to the body of the user.

In various exemplary embodiments, the communication mechanism is Bluetooth wireless RF. Thus, in various exemplary embodiments, there's no need to use a USB port for the hand glove mouse 100. Other embodiments communicate via a USB port.

Various exemplary embodiments include a USB charger that plugs into a USB port to charge the device. Other embodiments include a lithium polymer battery, a AAA battery, or other means of powering the device that are disposable and replaceable.

It should also be apparent that, as with the right button attachment 102, left button attachment 104 and on/off button attachment 106, the wrist attachment 110 is also adjustable in some embodiments. It should also be apparent that the hand glove mouse 100 comes in different sizes in order to fit properly on small user hands, large user hands and normal sized user hands.

In various exemplary embodiments, the buttons and sensors included with the exemplary hand glove mouse 100 are customizable. Thus, in such embodiments, the hand glove mouse 100 is capable of receiving communications including software to set up or upgrade, or otherwise alter, the configuration of one or more of the sensors and buttons included in each particular embodiment of the hand glove mouse 100. This can be performed through a USB port or by way of any other kind of connection including, but not limited to, those explicitly described herein.

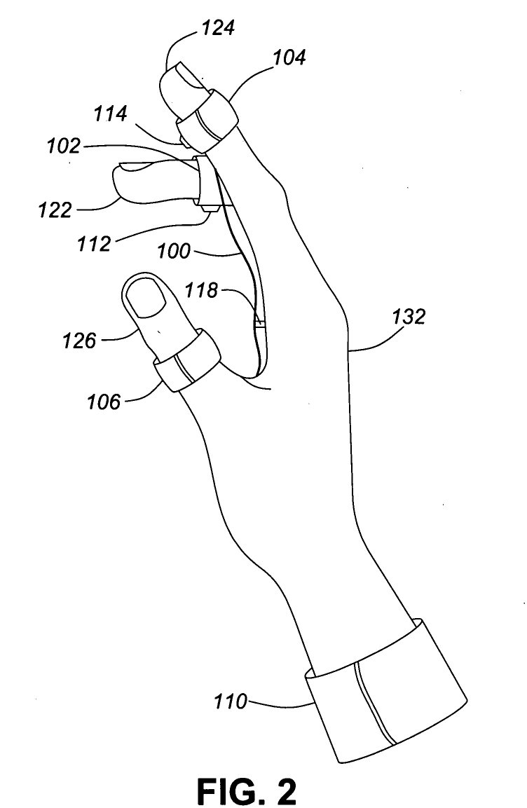

FIG. 2 is a perspective view of the right hand of the user from the left showing the exemplary hand glove mouse 100. Similar reference characters are used to show similar elements in FIG. 2 corresponding to those described above in connection with FIG. 1. The left button 114 and right button 112 are depicted as protruding somewhat from the surface of the left button connector 104 and right button connector 102, respectively. However, it should be apparent that, various sensors incorporated in other embodiments protrude less or more than the extent to which the left button 114 and the right button 112 are shown as protruding in FIG. 2. Thus, in some embodiments, the buttons and sensors incorporated in the device do not protrude at all.

In various exemplary embodiments, the hand glove mouse 100 is used for ordering products from a television, tuning a television, or in connection with the so-called “triple play” style of home entertainment. It should be apparent that the hand glove mouse 100 can be used in any manner that a wireless programmer could be used.

In various exemplary embodiments, the hand glove mouse 100, is used in connection with a reshaped keyboard wherein a portion of the keyboard between the letters and the numerical pad is used for receiving the positioning sensor 118 and as a surface for actuating other buttons and sensors included with the hand glove mouse 100. Such embodiments are believed to further reduce the amount of movement necessary to type on the keyboard and use the mouse 100.

Based on the foregoing, it is believed that the hand glove mouse 100 represents an improvement over known computer mouse devices. In particular, the sensors and switches are not positioned on the fingertips. Thus, the benefits described above in connection with mounting mouse sensors and buttons on the body of the user do not interfere with the ability of the user to type on a keyboard. Further, the risk of inadvertently repositioning a cursor on a computer monitor is reduced.

It should be apparent that, the exemplary embodiment of the hand glove mouse 100 depicted in FIGS. 1 and 2 does not cover any of the fingertips on the user's hand, and does not cover a ring finger 128 or a pinky finger 130 of the user at all. Similarly, it should be apparent that the hand glove mouse 100 does not surround the user's hand so as to cover a top portion 132 of the user's hand. Nevertheless, it should be apparent that other embodiments of the hand glove mouse 100 cover more or less portions of the user's hand than the depicted embodiment. Thus, in one embodiment the hand glove mouse 100 is a full glove. It should also be apparent that embodiments using a wireless form of communication have the benefit of enabling the user of the computer to walk away from the computer and keyboard while still wearing the hand glove mouse 100.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A hand glove mouse, comprising:
a first button;
a second button;
an third button;
a cursor positioner for adjusting the position of a cursor on a computer monitor using a light sensor;
a first button attachment for attaching the first button to a first location on a body of a user, the first location being a location other than a fingertip;
a second button attachment for attaching the second button to a second location on a body of a user, the second location being a location other than a fingertip;
a third button attachment for attaching the third button to a third location on a body of a user, the third location being a location other than a fingertip;
a cursor positioner attachment for attaching the cursor positioner to a fourth location on a body of a user, the fourth location being a location other than a fingertip; and
a communication means in communication with a computer, the communication means communicating signals generated by the first button, the second button, the third button, and by the cursor positioner.

2. The hand glove mouse according to claim 1, wherein the first button attachment, the second button attachment, and the third button attachment attach the first button, the second button, and the third button to a hand of the user.

3. The hand glove mouse according to claim 2, wherein the first button attachment, the second button attachment, and the third button attachment are sleeves surrounding fingers on the hand of the user.

4. The hand glove mouse according to claim 3, wherein the first button attachment surrounds a middle finger on the hand of the user, the second button attachment surrounds a pointer finger on the hand of the user, and the third button attachment surrounds a thumb on the hand of the user.

5. The hand glove mouse according to claim 4, wherein the third button is an on/off button.

6. The hand glove mouse according to claim 1, wherein the cursor positioner is an optical sensor.

7. The hand glove mouse according to claim 1, wherein the cursor positioner is a roller ball.

8. The hand glove mouse according to claim 1, wherein none of the user's fingertips are obstructed when the hand glove mouse is installed on the user's body.

9. The hand glove mouse according to claim 8, wherein at least seven of the user's fingers are completely unobstructed when the hand glove mouse is installed on the user's body.

10. The hand glove mouse according to claim 1, further comprising a full glove worn on a hand of the user.

11. The hand glove mouse according to claim 1, wherein the communication means is an electrical signal carrying wire.

12. The hand glove mouse according to claim 1, wherein the communication means is wireless.

13. The hand glove mouse according to claim 12, wherein the communication means uses a radio frequency.

14. The hand glove mouse according to claim 12, wherein the communication means uses Bluetooth.

15. The hand glove mouse according to claim 1, further comprising programmable software by which a function of the first button, a function of the second button, and a function of the third button, can be reconfigured.

16. The hand glove mouse according to claim 1, further comprising a power source.

17. The hand glove mouse according to claim 16, wherein the power source is rechargeable.

18. The hand glove mouse according to claim 17, wherein the rechargeable power source is recharged by a USB charger that plugs into a USB port of the computer.

19. A hand glove mouse, comprising:
a first button;
a second button;
an third button;
a cursor positioner for adjusting the position of a cursor on a computer monitor using a roller ball;
a first button attachment for attaching the first button to a first location on a body of a user, the first location being a location other than a fingertip;
a second button attachment for attaching the second button to a second location on a body of a user, the second location being a location other than a fingertip;
a third button attachment for attaching the third button to a third location on a body of a user, the third location being a location other than a fingertip;
a cursor positioner attachment for attaching the cursor positioner to a fourth location on a body of a user, the fourth location being a location other than a fingertip; and
a communication means in communication with a computer, the communication means communicating signals generated by the first button, the second button, the third button, and by the cursor positioner.

20. A hand glove mouse, comprising:
a first load sensor on a first fingertip, the second load sensor having an actuation threshold that is above a load that arises during typing on a keyboard;
a second load sensor on a second fingertip, the second load sensor having an actuation threshold that is above the load that arises during typing on a keyboard;
a third load sensor on a third fingertip, the third load sensor having an actuation threshold that is above the load that arises during typing on a keyboard;
a cursor positioner for adjusting the position of a cursor on a computer monitor; and
a communication means in communication with a computer, the communication means communicating signals generated by the first button, the second button, the third button, and by the cursor positioner.
